(19) United States
(12) Patent Application Publication
(10) Pub. No.: US 2021/0311555 A1
(43) Pub. Date: Oct. 7, 2021

(54) METHOD AND DEVICE FOR GESTURE DETECTION, MOBILE TERMINAL AND STORAGE MEDIUM

(71) Applicant: BEIJING XIAOMI MOBILE SOFTWARE CO., LTD., Beijing (CN)

(72) Inventor: Chin-lung LI, Beijing (CN)

(73) Assignee: BEIJING XIAOMI MOBILE SOFTWARE CO., LTD., Beijing (CN)

(21) Appl. No.: 17/039,214

(22) Filed: Sep. 30, 2020

(30) Foreign Application Priority Data
Apr. 3, 2020 (CN) 202010257410.X

(51) Int. Cl. G06F 3/01; G01S 13/62; G01S 7/41; G01S 7/48; G01S 7/292; G06N 20/00

(52) U.S. Cl. CPC G06F 3/017; G01S 13/62; G06N 20/00; G01S 7/4808; G01S 7/292; G01S 7/415

(57) ABSTRACT

Provided are a method and device for gesture detection, a mobile terminal, and a storage medium. The method is applied to a mobile terminal and includes: transmitting a radar wave; receiving an echo returned in response to the radar wave; determining a first relative motion parameter of an object to be detected in an influence scope of the radar wave relative to the mobile terminal based on a transmitting parameter for the radar wave and a receiving parameter for the echo; detecting a terminal motion parameter of the mobile terminal; adjusting the first relative motion parameter based on the terminal motion parameter to obtain a second relative motion parameter; and performing machine learning on the second relative motion parameter through a preset gesture recognition model to obtain a gesture recognition result.

### CROSS-REFERENCE TO RELATED APPLICATION

This application is based upon and claims priority to Chinese Patent Application No. 202010257410.X filed on Apr. 3, 2020, the entire contents of which are incorporated herein by reference for all purposes.

### TECHNICAL FIELD

The present disclosure generally relates to the field of intelligent control, and particularly, to a method and device for gesture detection, a mobile terminal and a storage medium.

### BACKGROUND

When unlocking or control is implemented by detecting a gesture through a mobile phone, an attitude of the gesture is usually determined through a radar sensor arranged in the mobile phone to further recognize and determine the gesture. By this detection method, when a transmitter of a radar wave, i.e., the mobile phone, is fixed and vertical to the ground, an accurate result may be obtained. However, the mobile phone is a mobile device that, in a using process, cannot be kept stable and maintained at a perfect vertical attitude angle. In such case, detected gesture data may be wrong.

### SUMMARY

According to a first aspect of the present disclosure, a method for gesture detection may be applicable to a mobile terminal and may include: transmitting a radar wave; receiving an echo returned in response to the radar wave; determining a first relative motion parameter of an object to be detected in an influence scope of the radar wave relative to the mobile terminal based on a transmitting parameter for the radar wave and a receiving parameter for the echo; detecting a terminal motion parameter of the mobile terminal; adjusting the first relative motion parameter based on the terminal motion parameter to obtain a second relative motion parameter; and performing machine learning on the second relative motion parameter through a preset gesture recognition model to obtain a gesture recognition result.

According to a second aspect of the present disclosure, a mobile terminal is provided, which may include: a radar antenna array, configured to transmit a radar wave and receive an echo returned in response to the radar wave; an inertial sensor, configured to detect a terminal motion parameter of the mobile terminal; and at least one processor, connected with the radar antenna array and the inertial sensor and configured to determine a first relative motion parameter of an object to be detected in an influence scope of the radar wave relative to the mobile terminal based on a transmitting parameter for the radar wave and a receiving parameter for the echo, adjust the first relative motion parameter based on the terminal motion parameter to obtain a second relative motion parameter and perform machine learning on the second relative motion parameter through a preset gesture recognition model to obtain a gesture recognition result.

According to a third aspect of the present disclosure, a device for gesture detection is also provided, which may include: a processor; and memory configured to store instructions executable by the processor, wherein the processor may be configured to run the executable instructions stored in the memory to implement any method of the first aspect.

According to a fourth aspect of the present disclosure, a non-transitory computer-readable storage medium has stored instructions therein that, when executed by a processor of a device for gesture detection to cause the device for gesture detection to implement any method of the first aspect.

It is to be understood that the above general descriptions and detailed descriptions below are only exemplary and explanatory and not intended to limit the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 shows two recognition errors that may occur during use of a mobile terminal according to an example.

FIG. 2 is a first flowchart showing a method for gesture detection according to an example.

FIG. 3 is a schematic diagram illustrating a first relative motion parameter of a palm relative to a mobile terminal according to an example.

FIG. 4 is a second flowchart showing a method for gesture detection according to an example.

FIG. 5 is a third flowchart showing a method for gesture detection according to an example.

FIG. 6 is a structure block diagram of a mobile terminal according to an example.

FIG. 7 is a block diagram of a device for gesture detection according to an example.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

A principle for detecting a gesture through a mobile terminal is that: a radar sensor is mounted in a mobile phone, a parameter of relative motion the radar sensor to a palm is calculated, and then a gesture is determined based on the parameter of relative motion. Based on this detection method, when the radar sensor is fixed and vertical to the ground, an accurate result may be obtained. However, during an actual application, in a using process of the mobile terminal such as the mobile phone, the mobile phone cannot be kept stable and maintained at a perfect vertical attitude angle. The radar sensor may move accordingly. For example, during walking, the mobile terminal may vibrate or be inclined at a certain angle, and in such case, a recognition error may occur.

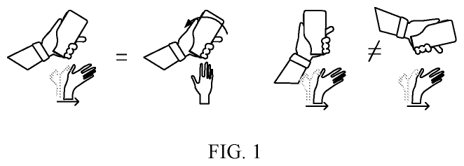

FIG. 1 shows two recognition errors that may occur during use of a mobile terminal according to an example. As shown in the left part of FIG. 1, a user does not wave the hand, but if the mobile terminal excessively shakes leftwards and rightwards, it is equivalent to a leftward and rightward waving movement of the user. As shown in the right part of FIG. 1, when the mobile terminal is used, if an inclination angle is excessively large and the mobile terminal is approximately in a landscape mode, the leftward and rightward waving may be detected as upward and downward waving. It can thus be seen that, if only data detected by the radar sensor is adopted for recognition in a process of recognizing a gesture through the mobile terminal, an error may occur to a great extent.

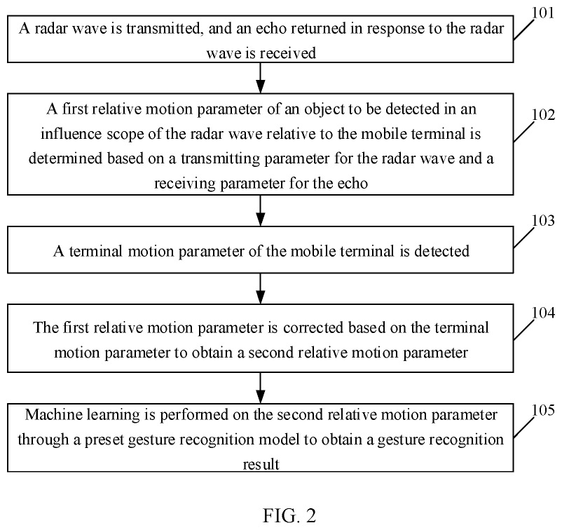

For obtaining a relative motion parameter of an object to be detected to a mobile terminal more accurately to implement gesture recognition, the embodiments of the present disclosure provide a method for gesture detection, which is applicable to a mobile terminal. FIG. 2 is a first flowchart showing a method for gesture detection according to an example. As shown in FIG. 2, the method includes the following operations.

In Operation 101, a radar wave is transmitted, and an echo returned in response to the radar wave is received.

In Operation 102, a first relative motion parameter of an object to be detected in an influence scope of the radar wave relative to the mobile terminal is determined based on a transmitting parameter for the radar wave and a receiving parameter for the echo.

In Operation 103, a terminal motion parameter of the mobile terminal is detected.

In Operation 104, the first relative motion parameter is adjusted based on the terminal motion parameter to obtain a second relative motion parameter.

In Operation 105, machine learning is performed on the second relative motion parameter through a preset gesture recognition model to obtain a gesture recognition result. Here, the machine learning algorithm may be based on Convolutional Neural Networks (CNN), Recurrent Neural Networks (RNN), or Long Short-Term Memory (LSTM) architecture. The inputs to the machine learning algorithm may include one or more of following parameters: the device attitude parameter, relative speed, relative distance, and relative angle.

It is to be noted that the mobile terminal refers to any mobile electronic device, including a smart phone, a tablet computer, a notebook computer or a smart watch.

A radar sensor is mounted in the mobile terminal. The radar sensor may include a transmitting antenna and a receiving antenna. The receiving antenna and the transmitting antenna may form a radar antenna array and are configured to transmit the radar wave and receive the echo returned based on the radar wave. Specifically, a motion condition of the object to be detected in the influence scope of the radar wave may be detected through a transmitting parameter for the radar wave transmitted by the transmitting antenna and the echo received by the receiving antenna and returned in response to the radar wave.

In the embodiments of the present disclosure, the object to be detected may be an object for making a gesture, such as a palm or a finger.

A gesture may be for non-contact unlocking of the mobile terminal. A gesture may execute some control operations, for example, a leftward or rightward sliding gesture may be for page switching. Or, a gesture may implement a fruit slicing operation in a fruit slicing game.

The radar sensor may be arranged on a surface where a display screen of the mobile terminal is located, or on a surface opposite to the surface where the display screen is located, i.e., a back surface of the mobile terminal, or arranged on an end face (i.e., lateral surface) of the display screen.

It is to be noted that, when the radar sensor is on the surface where the display screen is located, a small area of the display screen may be occupied and more application requirements can be met. When the radar sensor is on the surface opposite to the surface where the display screen is located, no area of the display screen may be occupied, but fewer application requirements can be met. When the radar sensor is on the end face (i.e., the lateral surface) of the display screen, no area of the display screen is occupied, and a larger scope may be covered compared with that covered when the radar sensor is on the back surface. Therefore, a mounting position of the radar sensor may be set according to an actual requirement.

In some embodiments, since the mobile terminal is also in a moving state when detecting is conducted for the object to be detected, detecting the motion condition of the object to be detected in the influence scope of the radar wave specifically refers to detecting the first relative motion parameter of the object to be detected in the influence scope of the radar wave relative to the mobile terminal by transmitting the radar wave.

The first relative motion parameter refers to a relative motion parameter detected through the radar sensor during motion of the object to be detected relative to the mobile terminal.

In some embodiments, the first relative motion parameter may include a relative speed, and/or a relative angle and/or a relative distance.

The relative speed refers to a speed detected during the motion of the object to be detected relative to the mobile terminal. The relative angle refers to an angle detected during the motion of the object to be detected relative to the mobile terminal. Both the relative speed and the relative angle are values acquired during the motion of the object to be detected relative to the mobile terminal rather than values acquired during the motion of the object to be detected relative to the ground. The relative distance is a distance, detected during the motion of the object to be detected relative to the mobile terminal, between the object to be detected and the mobile terminal.

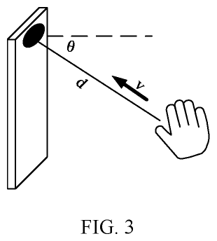

FIG. 3 is a schematic diagram illustrating a first relative motion parameter of a palm relative to a mobile terminal according to an example. The first relative motion parameter of the palm relative to the mobile terminal in FIG. 3 includes a relative speed v, a relative angle θ and a relative distance d.

During the actual application, a relative motion parameter of the object to be detected relative to the mobile terminal may be obtained, and another relative motion parameter of the object to be detected relative to the ground may also be obtained. The first relative motion parameter relative to the mobile terminal may be detected, and a third relative motion parameter relative to the ground may be detected. For all moving objects, the ground is stationary. Therefore, in the embodiments of the present disclosure, the third relative motion parameter, detected relative to the ground, of the object to be detected may also be called an actual motion parameter of the object to be detected. The actual motion parameter of the object to be detected includes an actual speed and/or an actual angle.

The terminal motion parameter of the mobile terminal refers to various parameters representing a motion state of the mobile terminal during a motion relative to the ground. The terminal motion parameter of the mobile terminal is a motion parameter detected relative to the ground and thus is also considered as an actual motion parameter of the mobile terminal.

In some embodiments, the terminal motion parameter of the mobile terminal may include at least one of following parameters: an attitude parameter, a movement acceleration, and a rotation angular speed. For example, the terminal motion parameter may include only one of the parameters, two of the parameters, or all of the parameters.

The attitude parameter represents a placement state of the mobile terminal, including placement in a landscape mode or placement in a portrait mode. The movement acceleration refers to an acceleration during movement of the mobile terminal relative to the ground, i.e., an actual motion acceleration of the mobile terminal. An integral operation may be executed on the movement acceleration to obtain the movement speed or the movement distance. Specifically, a single integral operation may be performed on the movement acceleration to obtain the movement speed. A double integral operation may be performed on the movement acceleration to obtain the movement distance. Both the movement speed and the movement distance refer to motion values of the mobile terminal relative to the ground.

The rotation angular speed refers to an angular speed detected during rotation of the mobile terminal relative to the ground, i.e., an actual rotation angular speed of the mobile terminal.

When the object to be detected and the mobile terminal motion in the same direction, the relative speed in the first relative motion parameter may include a difference between the actual speed of the object to be detected and the movement speed of the mobile terminal.

It is to be noted that, if the mobile terminal transmits the radar wave when being in a stationary state and vertical to the ground, the first relative motion parameter detected based on the radar wave refers to the actual motion parameter of the object to be detected relative to the ground. In such case, all the movement acceleration, rotation angular speed and the like in the terminal motion parameter of the mobile terminal are 0. Since the terminal motion parameter has no interference to the first relative motion parameter, it is unnecessary to adjust the first relative motion parameter based on the terminal motion parameter. Therefore, motion detection of the object to be detected in the embodiments of the present disclosure is detection of the object to be detected by the mobile terminal in the motion state.

Since the first relative motion parameter, determined by the mobile terminal in the motion state in the manner of transmitting the radar wave, of the motion of the object to be detected relative to the mobile terminal may not reflect an actual motion state of the object to be detected, detection may also be conducted for the terminal motion parameter of the mobile terminal the embodiments of the present disclosure. The first relative motion parameter may be adjusted based on the terminal motion parameter to obtain the second relative motion parameter.

The second relative motion parameter refers to a relative motion parameter obtained by correction and specifically refers to a motion parameter reflecting the actual motion state of the object to be detected. The operation that the first relative motion parameter is adjusted based on the terminal motion parameter may include that: the terminal motion parameter is added or subtracted based on the first relative motion parameter.

For example, in a situation that the object to be detected does not motion but the mobile terminal shakes leftwards and rightwards, the first relative motion parameter, detected in such case, of the object to be detected is actually the terminal motion parameter of the mobile terminal. Since the object to be detected does not motion, both the actual movement speed and rotation angle of the object to be detected are 0. For obtaining the second relative motion parameter, subtraction may be performed on the first relative motion parameter and the terminal motion parameter.

For another example, in a situation that the object to be detected moves to direction A and the mobile terminal also swings to the direction A, when the movement speed of the object to be detected is the same as a swinging speed of the mobile terminal, both the relative speed and relative angle in the detected first relative motion parameter of the object to be detected are 0, namely it is determined that the object to be detected is stationary relative to the mobile terminal. However, the object to be detected actually is moving, there is a motion generated at this moment. The movement acceleration and rotation angular speed in the detected terminal motion parameter are a movement acceleration and rotation angular speed of the object to be detected. In such case, the first relative motion parameter and the terminal motion parameter are needed to be added to obtain the second relative motion parameter.

For another example, in a situation that the object to be detected moves to direction A and the mobile terminal swings to direction B, the directions A and B being opposite, the relative speed in the first relative motion parameter, detected in such case, of the object to be detected is a sum of the actual movement speed of the object to be detected and the movement speed in the terminal motion parameter. In such case, it is needed to perform subtraction on the first relative motion parameter and the terminal motion parameter to obtain the second relative motion parameter.

The movement direction of the mobile terminal may include a direction that the display screen faces, a direction vertical to the direction that the display screen faces, or another direction. In case of movement to the direction that the display screen faces, it may be determined that the mobile terminal moves forwards and backwards. In case of movement to the direction vertical to the direction that the display screen faces, it may be determined that the mobile terminal moves leftwards and rightwards. Another direction may be a direction other than forward-backward movement and leftward-rightward movement.

However, it is to be noted that the relative distance, the relative speed and the relative angle may exist for the mobile terminal and the object to be detected regardless of the movement direction. When the first relative motion parameter is adjusted, the terminal motion parameter of the mobile terminal may be decomposed to directions the same as and vertical to the movement direction of the object to be detected based on the movement direction of the object to be detected to adjust the first relative motion parameter.

In some embodiments, the gesture recognition model may be a model pretrained to recognize a dynamic pose of the object to be detected in preset time.

The gesture recognition model may be any neural network model capable of implementing prediction, for example, a Convolutional Neural Network (CNN) or a Long Short-Term Memory (LSTM) model.

The operation that the gesture recognition model is determined may include that: after a neural network model is selected, the neural network model is trained according to experimental data to obtain the gesture recognition model. The experimental data may include relative motion parameters and gesture recognition results corresponding to the relative motion parameters. The gesture recognition result may be represented by a percentage, i.e., similarities between the relative motion parameter and motion parameters of various gestures. The gesture with the maximum similarity is selected as a finally recognized gesture.

After the gesture recognition model is trained, the second relative motion parameter obtained by correction may be input to the gesture recognition model to obtain the gesture recognition result.

In such a manner, based on the first relative motion parameter, detected based on the radar wave, of the object to be detected and considering the impact of a motion of the mobile terminal on the first relative motion parameter, the first relative motion parameter may be adjusted based on the detected terminal motion parameter to obtain a parameter of relative motion of the object to be detected to the mobile terminal more accurately. After the more accurate relative motion parameter is obtained, more accurate second relative motion parameter may be processed by machine learning through the preset gesture recognition model, so that the gesture recognition result is more accurate.

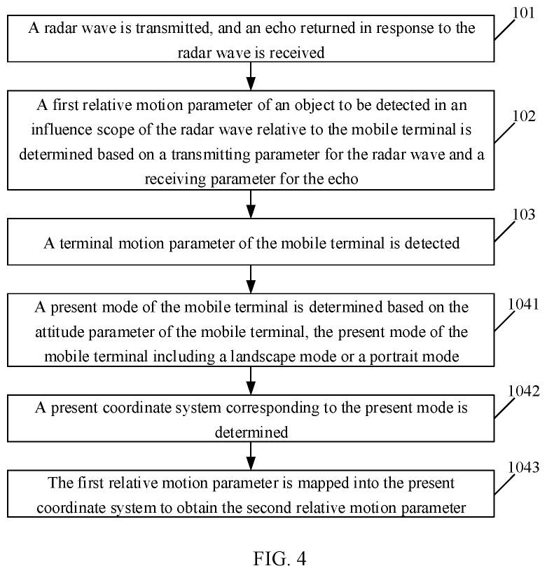

In some embodiments, FIG. 4 is a second flowchart showing a method for gesture detection according to an example. As shown in FIG. 4, the operation 104 that the first relative motion parameter is adjusted based on the terminal motion parameter to obtain the second relative motion parameter may include the following operations.

In Operation 1041, a present mode of the mobile terminal is determined based on the attitude parameter of the mobile terminal, the present mode of the mobile terminal including a landscape mode or a portrait mode.

In Operation 1042, a present coordinate system corresponding to the present mode is determined.

In Operation 1043, the first relative motion parameter is mapped into the present coordinate system to obtain the second relative motion parameter.

The attitude parameter of the mobile terminal represents an attitude of a body of the mobile terminal. The attitude of the body of the mobile terminal may be a landscape attitude or a portrait attitude. The attitude of the body of the mobile terminal may also be taken as an attitude of the display screen. When the attitude of the body of the mobile terminal is the landscape attitude, a corresponding present mode of the mobile terminal is the landscape mode. When the attitude of the body of the mobile terminal is the portrait attitude, the corresponding present mode of the mobile terminal is the portrait mode.

The attitude parameter may be acquired through an inertial sensor mounted in the mobile terminal. The inertial sensor may include a gravity sensor, an acceleration sensor or a gyroscope.

In some embodiments, the attitude parameter may be detected with reference to a gravity direction. For example, an included angle between a centerline of the mobile terminal and a present gravity direction may be detected. For detecting an attitude change of the display screen, the gravity sensor may be adopted for detection. When the present mode of the mobile terminal is changed from the landscape mode to the portrait mode or changed from the portrait mode to the landscape mode, a gravity direction of a gravity block in the gravity sensor changes, and then a force of the gravity block on a piezoelectric crystal also changes, so that it is detected that the attitude of the body of the mobile terminal changes.

Therefore, the operation that the present mode of the mobile terminal is determined based on the attitude parameter of the mobile terminal may be implemented as follows: the attitude of the display screen of the mobile terminal is determined based on a magnitude and direction, detected by the gravity sensor, of the force on the piezoelectric crystal; and the present mode of the mobile terminal is determined based on the attitude of the display screen.

The present coordinate system corresponding to the present mode may include a coordinate system in the landscape mode or a coordinate system in the portrait mode. The coordinate system in the landscape mode may be obtained by rotating the coordinate system in the portrait mode 90 degrees, namely changing a horizontal ordinate and a vertical ordinate.

Mapping the first relative motion parameter into the present coordinate system refers to mapping the first relative motion parameter into the coordinate system in the corresponding landscape mode or the coordinate system in the portrait mode. For example, if it is detected that the display screen of the mobile terminal is changed to the portrait mode, the first relative motion parameter represented by the coordinate system in the landscape mode is mapped into the coordinate system in the portrait mode to obtain the second relative motion parameter.

When the motion state of the object to be detected is detected, if the attitude of the display screen is changed, the coordinate system representing the relative motion parameter is also changed correspondingly. In such a manner, misjudgments in the detected movement direction of the object to be detected due to changes of the attitude of the display screen can be reduced, and a correct relative motion parameter can be further obtained by correction.

In some embodiments, the method may further include that:

a movement speed and/or movement distance of the mobile terminal are/is determined according to the movement acceleration of the mobile terminal; and

a rotation angle of the mobile terminal is determined according to the rotation angular speed of the mobile terminal.

The movement acceleration of the mobile terminal may be directly detected through the inertial sensor. Since a ratio of the movement speed to movement time is the movement acceleration, the single integral operation may be performed on the movement acceleration to calculate the movement speed.

Correspondingly, since the movement distance is directly proportional to a square of the movement acceleration, the double integral operation may be performed on the movement acceleration to calculate the movement distance.

Similarly, the rotation angular speed of the mobile terminal may also be directly detected through the inertial sensor. Since the rotation angular speed is a ratio of the rotation angle to rotation time, the single integral operation may be executed on the detected rotation angular speed to obtain the rotation angle.

In some embodiments, the operation 104 that the first relative motion parameter is adjusted based on the terminal motion parameter to obtain the second relative motion parameter may include at least one of following:

the relative speed is adjusted according to the movement speed of the mobile terminal to determine the second relative motion parameter;

the relative distance is adjusted according to the movement distance of the mobile terminal to determine the second relative motion parameter; and

the relative angle is adjusted according to the rotation angle of the mobile terminal to determine the second relative motion parameter.

As mentioned above, the movement speed refers to the movement speed of the mobile terminal relative to the ground, i.e., the actual movement speed of the mobile terminal.

The operation that the relative speed is adjusted according to the movement speed of the mobile terminal to determine the second relative motion parameter may include that: the second relative motion parameter is determined according to subtraction or addition of the movement speed of the mobile terminal and the relative speed.

Subtraction or addition of the movement speed of the mobile terminal and the relative speed may be determined based on a specific condition, namely:

determining whether a translation direction of the mobile terminal is opposite to or the same as the movement direction of the object to be detected;

when the translation direction of the mobile terminal is opposite to the movement direction of the object to be detected, performing subtraction on a numerical value of the movement speed of the mobile terminal and a numerical value of the relative speed to determine the second relative motion parameter; or

when the translation direction of the mobile terminal is the same as the movement direction of the object to be detected, adding the numerical value corresponding to the movement speed of the mobile terminal and the numerical value corresponding to the relative speed to determine the second relative motion parameter.

When the translation direction of the mobile terminal is opposite to the movement direction of the object to be detected, the relative speed in the detected first relative motion parameter is a sum of the numerical value corresponding to the movement speed of the mobile terminal in the direction opposite to the translation direction of the mobile terminal and a numerical value corresponding to the actual speed of the object to be detected. In such case, for obtaining the second relative motion parameter, i.e., the actual speed, it is needed to subtract the numerical value corresponding to the movement speed of the mobile terminal from the numerical value corresponding to the relative speed.

When the translation direction of the mobile terminal is the same as the movement direction of the object to be detected, the relative speed in the detected first relative motion parameter is a difference of the numerical value corresponding to the movement speed of the mobile terminal and the numerical value corresponding to the actual speed of the object to be detected. In such case, for obtaining the second relative motion parameter, it is needed to add the numerical value corresponding to the relative speed and the numerical value corresponding to the movement speed of the mobile terminal.

The translation direction of the mobile terminal and the movement direction of the object to be detected may further include the following condition: the translation direction of the mobile terminal forms a certain included angle with the movement direction of the object to be detected. Existence of the certain included angle means that the translation direction of the mobile terminal and the movement direction of the object to be detected are vertical or have a non-vertical included angle.

That the translation direction of the mobile terminal and the movement direction of the object to be detected are vertical refers to that the mobile terminal moves leftwards and rightwards but the object to be detected moves forwards and backwards. In such case, a detected speed of the object to be detected in a left-right direction is 0, namely the first relative motion parameter detected in the left-right direction is the same as the movement speed of the mobile terminal, and subtraction is performed on the movement speed of the mobile terminal and the relative speed in the first relative motion parameter to determine the second relative motion parameter in the left-right direction.

In the condition that the translation direction of the mobile terminal and the movement direction of the object to be detected form a non-vertical included angle, the relative speed in the direction of the non-vertical included angle may be decomposed to a first speed in a direction parallel to the translation direction of the mobile terminal and a second speed in the direction vertical to the translation direction of the mobile terminal. When the first speed is the same as the translation direction of the mobile terminal, the movement speed of the mobile terminal and the first speed obtained by decomposing the relative speed are added to determine the second relative motion parameter.

It is to be noted that adjusting the relative speed according to the movement speed of the mobile terminal may include correcting the relative speed based on the movement speed when a state of the display screen of the mobile terminal does not change. When the state of the display screen of the mobile terminal changes, subtraction or addition may be performed on the movement speed of the mobile terminal and the relative speed to determine the second relative motion parameter after the coordinate system representing the relative motion parameter is correspondingly changed.

Similarly, the operation that the relative distance is adjusted or corrected according to the movement distance of the mobile terminal to determine the second relative motion parameter may include that: the second relative motion parameter is determined based on subtraction or addition of the movement distance of the mobile terminal and the relative distance.

Subtraction or addition of the movement distance of the mobile terminal and the relative distance may be determined based on a specific condition, namely:

determining whether the translation direction of the mobile terminal is opposite to or the same as the movement direction of the object to be detected;

when the translation direction of the mobile terminal is opposite to the movement direction of the object to be detected, performing subtraction on a numerical value corresponding to the movement distance of the mobile terminal and a numerical value corresponding to the relative distance to determine the second relative motion parameter; and

when the translation direction of the mobile terminal is the same as the movement direction of the object to be detected, adding the numerical value corresponding to the movement distance of the mobile terminal and the numerical value corresponding to the relative distance to determine the second relative motion parameter.

The translation direction of the mobile terminal and the movement direction of the object to be detected may further include the following condition: the translation direction of the mobile terminal forms a certain included angle with the movement direction of the object to be detected. When there is a movement included angle, the movement distance of the mobile terminal is decomposed to a first movement distance in the direction the same as the movement direction of the object to be detected and a second movement distance in the direction vertical to it. Since the first movement distance is the same as the movement direction of the object to be detected, the second relative motion parameter may be determined by processing based on the first movement distance based on the corresponding processing condition when the translation direction of the mobile terminal is the same as the movement direction of the object to be detected.

Based on this, the operation that the relative angle is adjusted or corrected according to the rotation angle of the mobile terminal to determine the second relative motion parameter may include that:

subtraction or addition is performed on the rotation angle and the relative angle to determine the second relative motion parameter.

Subtraction or addition of the rotation angle and the relative angle may be determined based on a specific condition, namely:

determining whether a rotation direction of the mobile terminal is opposite to or the same as a rotation direction of the object to be detected;

when the rotation direction of the mobile terminal is opposite to the rotation direction of the object to be detected, performing subtraction on the rotation angle of the mobile terminal and the relative angle to determine the second relative motion parameter; and

when the rotation direction of the mobile terminal is the same as the rotation direction of the object to be detected, adding the rotation angle of the mobile terminal and the relative angle to determine the second relative motion parameter.

When the rotation direction of the mobile terminal is opposite to the rotation direction of the object to be detected, the relative angle in the detected first relative motion parameter is a difference between the rotation angle of the mobile terminal and the actual angle of the object to be detected. In such case, for obtaining the second relative motion parameter, it is needed to subtract the rotation angle of the mobile terminal from the relative angle.

Therefore, a more accurate relative motion parameter may be obtained by adjusting or correcting the relative speed according to the movement speed of the mobile terminal, adjusting or correcting the relative angle according to the rotation angle of the mobile terminal and/or adjusting or correcting the relative distance according to the movement distance of the mobile terminal to lay a foundation for subsequent motion pose recognition implemented based on the relative motion parameter.

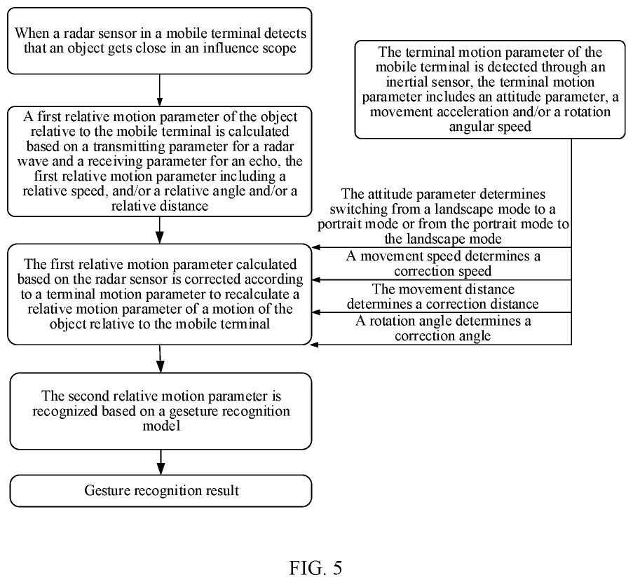

FIG. 5 is a third flowchart showing a method for gesture detection according to an example. The method for gesture detection in the embodiment of the present disclosure may be as follows: when a radar sensor in a mobile terminal detects that an object gets close in an influence scope, a first relative motion parameter of the object relative to the mobile terminal is calculated based on a transmitting parameter for a radar wave and a receiving parameter for an echo. The first relative motion parameter may include a relative speed, and/or a relative angle and/or a relative distance.

Meanwhile, a terminal motion parameter of the mobile terminal may be detected through an inertial sensor. The terminal motion parameter may include at least one of following parameters: an attitude parameter, a movement acceleration, and a rotation angular speed. It may be determined based on the attitude parameter that a screen of the mobile terminal is changed from a landscape mode to a portrait mode or from the portrait mode to the landscape mode. A corrected speed for the first relative motion parameter may be determined through a movement speed calculated according to the movement acceleration. A corrected distance for the first relative motion parameter may be determined through a movement distance calculated according to the movement acceleration. A corrected angle for the first relative motion parameter may be determined through a rotation angle calculated according to the rotation angular speed. The first relative motion parameter calculated based on the radar sensor may be further corrected based on the terminal motion parameter to recalculate a relative motion parameter (second relative motion parameter) of the object relative to the mobile terminal. The second relative motion parameter may be finally recognized based on a gesture recognition model to obtain a gesture recognition result.

Accordingly, after the radar wave is transmitted to determine the first relative motion parameter of the object to be detected relative to the mobile terminal, the terminal motion parameter of the mobile terminal may be further detected, and the first relative motion parameter may be adjusted or corrected based on the terminal motion parameter to obtain the second relative motion parameter of the object to be detected. Data acquisition inaccuracy caused when the mobile terminal is not fixed or there is an inclination angle in the landscape or portrait mode can be effectively solved. Correction based on the terminal motion parameter may keep accurate detection over the motion parameter of the object to be detected to further obtain a more accurate gesture recognition result by recognition based on the corrected motion parameter and the gesture recognition model.

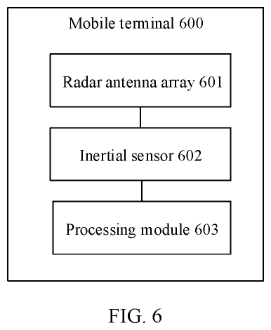

For obtaining a relative motion of an object to be detected and a mobile terminal more accurately, the embodiments of the present disclosure provide a mobile terminal. FIG. 6 is a structure block diagram of a mobile terminal according to an example. As shown in FIG. 6, the mobile terminal 600 includes:

a radar antenna array 601, configured to transmit a radar wave and receive an echo returned in response to the radar wave;

an inertial sensor 602, configured to detect a terminal motion parameter of the mobile terminal; and

a processing module 603, connected with the radar antenna array and the inertial sensor and configured to determine a first relative motion parameter of an object to be detected in an influence scope of the radar wave relative to the mobile terminal based on a transmitting parameter for the radar wave and a receiving parameter for the echo, adjust or correct the first relative motion parameter based on the terminal motion parameter to obtain a second relative motion parameter and perform machine learning on the second relative motion parameter through a preset gesture recognition model to obtain a gesture recognition result.

In some embodiments, the terminal motion parameter may include at least one of following parameters: an attitude parameter, a movement acceleration, and a rotation angular speed. The first relative motion parameter may include at least one of following relative parameters: a relative speed, a relative angle, and a relative distance.

In some embodiments, the at least one processor is specifically configured to:

determine a present mode of the mobile terminal based on the attitude parameter of the mobile terminal, the present mode of the mobile terminal including a landscape mode or a portrait mode;

determine a present coordinate system corresponding to the present mode; and

map the first relative motion parameter into the present coordinate system to obtain the second relative motion parameter.

In some embodiments, the at least one processor is further specifically configured to:

determine a movement speed and/or movement distance of the mobile terminal according to the movement acceleration, detected by the inertial sensor, of the mobile terminal; and

determine a rotation angle of the mobile terminal according to the rotation angular speed, detected by the inertial sensor, of the mobile terminal.

The at least one processor is further specifically configured to implement at least one of following acts:

adjusting or correcting the relative speed according to the movement speed of the mobile terminal to determine the second relative motion parameter,

adjusting or correcting the relative distance according to the movement distance of the mobile terminal to determine the second relative motion parameter, and

adjusting or correcting the relative angle according to the rotation angle of the mobile terminal to determine the second relative motion parameter.

With respect to the module in the above embodiment, specific modes have been described in detail in the embodiment regarding the method, which will not be elaborated herein.

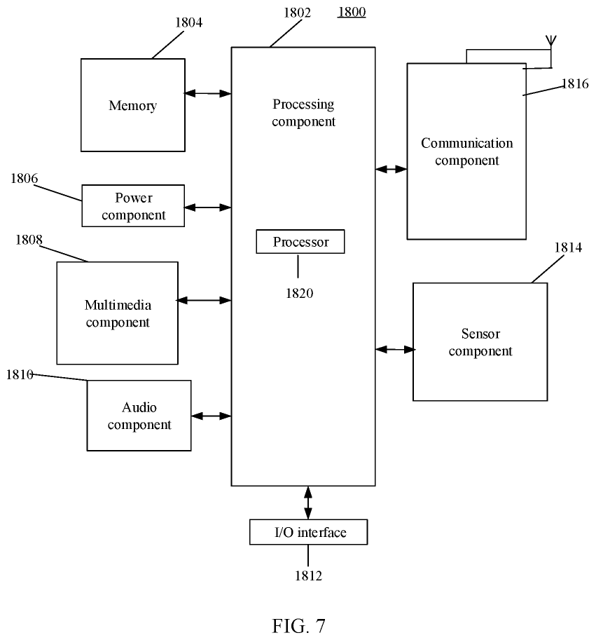

FIG. 7 is a block diagram of a device 1800 for gesture detection according to an example. For example, the device 1800 may be a mobile phone, a computer, a digital broadcast terminal, a messaging device, a gaming console, a tablet, a medical device, exercise equipment, a personal digital assistant and the like.

Referring to FIG. 7, the device 1800 may include one or more of the following components: a processing component 1802, memory 1804, a power component 1806, a multimedia component 1808, an audio component 1810, an Input/Output (I/O) interface 1812, a sensor component 1814, and a communication component 1816.

The processing component 1802 typically controls overall operations of the device 1800, such as the operations associated with display, telephone calls, data communications, camera operations, and recording operations. The processing component 1802 may include one or more processors 1820 to execute instructions to perform all or part of the operations in the abovementioned method. Moreover, the processing component 1802 may further include one or more modules which facilitate interaction between the processing component 1802 and the other components. For instance, the processing component 1802 may include a multimedia module to facilitate interaction between the multimedia component 1808 and the processing component 1802.

The memory 1804 is configured to store various types of data to support the operation of the device 1800. Examples of such data include instructions for any applications or methods operated on the device 1800, contact data, phonebook data, messages, pictures, video, etc. The memory 1804 may be implemented by any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, and a magnetic or optical disk.

The power component 1806 is configured to provide power for various components of the device 1800. The power component 1806 may include a power management system, one or more power supplies, and other components associated with generation, management and distribution of power for the device 1800.

The multimedia component 1808 may include a screen providing an output interface between the device 1800 and a user. In some embodiments, the screen may include a Liquid Crystal Display (LCD) and a Touch Panel (TP). If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action but also detect a duration and pressure associated with the touch or swipe action. In some embodiments, the multimedia component 1808 includes a front camera and/or a rear camera. The front camera and/or the rear camera may receive external multimedia data when the device 1800 is in an operation mode, such as a photographing mode or a video mode. Each of the front camera and/or the rear camera may be a fixed optical lens system or have focusing and optical zooming capabilities.

The audio component 1810 is configured to output and/or input an audio signal. For example, the audio component 1810 includes a Microphone (MIC), and the MIC is configured to receive an external audio signal when the device 1800 is in the operation mode, such as a call mode, a recording mode and a voice recognition mode. The received audio signal may further be stored in the memory 1804 or sent through the communication component 1816. In some embodiments, the audio component 1810 further includes a speaker configured to output the audio signal.

The I/O interface 1812 is configured to provide an interface between the processing component 1802 and a peripheral interface module, and the peripheral interface module may be a keyboard, a click wheel, a button and the like. The button may include, but not limited to: a home button, a volume button, a starting button and a locking button.

The sensor component 1814 may include one or more sensors configured to provide status assessment in various aspects for the device 1800. For instance, the sensor component 1814 may detect an on/off status of the device 1800 and relative positioning of components, such as a display and small keyboard of the device 1800, and the sensor component 1814 may further detect a change in a position of the device 1800 or a component of the device 1800, presence or absence of contact between the user and the device 1800, orientation or acceleration/deceleration of the device 1800 and a change in temperature of the device 1800. The sensor component 1814 may include a proximity sensor configured to detect presence of an object nearby without any physical contact. The sensor component 1814 may also include a light sensor, such as a Complementary Metal Oxide Semiconductor (CMOS) or Charge Coupled Device (CCD) image sensor, configured for use in an imaging application. In some embodiments, the sensor component 1814 may also include an acceleration sensor, a gyroscope sensor, a magnetic sensor, a pressure sensor or a temperature sensor.

The communication component 1816 is configured to facilitate wired or wireless communication between the device 1800 and another device. The device 1800 may access a communication-standard-based wireless network, such as a Wireless Fidelity (WiFi) network, a 2nd-Generation (2G) or 3rd-Generation (3G) network or a combination thereof. In an example, the communication component 1816 receives a broadcast signal or broadcast associated information from an external broadcast management system through a broadcast channel. In an example, the communication component 1816 further includes a Near Field Communication (NFC) module to facilitate short-range communication. For example, the NFC module may be implemented based on a Radio Frequency Identification (RFID) technology, an Infrared Data Association (IrDA) technology, an Ultra-WideBand (UWB) technology, a Bluetooth (BT) technology or another technology.

In an example, the device 1800 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute the abovementioned method.

In an example, there is also provided a non-transitory computer-readable storage medium storing instructions, such as the memory 1804 storing instructions, and the instructions may be executed by the processor 1820 of the device 1800 to implement the abovementioned method. For example, the non-transitory computer-readable storage medium may be a ROM, a Random Access Memory (RAM), a Compact Disc Read-Only Memory (CD-ROM), a magnetic tape, a floppy disc, an optical data storage device and the like.

According to a non-transitory computer-readable storage medium, an instruction in the storage medium is executable by a processor of a device for gesture detection to cause the device for gesture detection to implement the method for gesture detection.

The terms used in the present disclosure are for describing particular embodiments only, and are not intended to limit the present disclosure. The singular forms “a/an”, “the” and “this” used in the present disclosure and the appended claims are also intended to include the plural forms unless the context clearly indicates other meanings. It is to be understood that the term “and/or” as used herein refers to and includes any or all possible combinations of one or more associated listed items.

It is to be understood that although the terms first, second, third, etc. may be used to describe various information in the present disclosure, the information should not be limited to these terms. The terms are only used to distinguish the same type of information from each other. For example, without departing from the scope of the present disclosure, the first information may also be referred to as second information, and similarly, the second information may also be referred to as first information. Depending on the context, the word “if” as used herein may be interpreted as “during” or “when” or “in response to determination”.

The technical solutions provided in the embodiments of the present disclosure may have the following beneficial effects.

According to the embodiments of the present disclosure, a terminal motion parameter of a mobile terminal may be detected, and a first relative motion parameter of an object to be detected in an influence scope of a radar wave relative to the mobile terminal may be adjusted or corrected based on the obtained terminal motion parameter to obtain a second relative motion parameter. In such a manner, based on the first relative motion parameter, detected based on the radar wave, of the object to be detected and considering the impact of a motion of the mobile terminal on the first relative motion parameter, the first relative motion parameter may be adjusted or corrected based on the detected terminal motion parameter to obtain a parameter of relative motion (the second relative motion parameter) of the object to be detected to the mobile terminal more accurately. After the more accurate relative motion parameter is obtained, the more accurate second relative motion parameter may be processed by machine learning through a preset gesture recognition model, so that a gesture recognition result can be more accurate.

Other implementation solutions of the present disclosure will be apparent to those skilled in the art from consideration of the specification and practice of the present disclosure. This present disclosure is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the appended claims.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

What is claimed is:

1. A method for gesture detection, comprising:
transmitting, by a mobile terminal, a radar wave;
receiving, by the mobile terminal, an echo returned in response to the radar wave;
determining, by the mobile terminal, a first relative motion parameter of an object to be detected in an influence scope of the radar wave relative to the mobile terminal based on a transmitting parameter for the radar wave and a receiving parameter for the echo;
detecting, by the mobile terminal, a terminal motion parameter of the mobile terminal;
adjusting, by the mobile terminal, the first relative motion parameter based on the terminal motion parameter to obtain a second relative motion parameter; and
performing, by the mobile terminal, machine learning on the second relative motion parameter through a preset gesture recognition model to obtain a gesture recognition result.

2. The method of claim 1, wherein
the terminal motion parameter comprises at least one of following parameters: an attitude parameter, a movement acceleration, and a rotation angular speed; and
the first relative motion parameter comprises at least one of following relative parameters: a relative speed, a relative angle, and a relative distance.

3. The method of claim 2, wherein adjusting the first relative motion parameter based on the terminal motion parameter to obtain the second relative motion parameter comprises:
determining a present mode of the mobile terminal based on the attitude parameter of the mobile terminal, where the present mode of the mobile terminal comprises a landscape mode or a portrait mode;
determining a present coordinate system corresponding to the present mode; and
mapping the first relative motion parameter into the present coordinate system to obtain the second relative motion parameter.

4. The method of claim 2, further comprising:
determining a movement speed and/or movement distance of the mobile terminal according to the movement acceleration of the mobile terminal; and
determining a rotation angle of the mobile terminal according to the rotation angular speed of the mobile terminal;
wherein adjusting the first relative motion parameter based on the terminal motion parameter to obtain the second relative motion parameter comprises at least one of:
adjusting the relative speed according to the movement speed of the mobile terminal to determine the second relative motion parameter;
adjusting the relative distance according to the movement distance of the mobile terminal to determine the second relative motion parameter; and
adjusting the relative angle according to the rotation angle of the mobile terminal to determine the second relative motion parameter.

5. A mobile terminal, comprising:
a radar antenna array, configured to transmit a radar wave and receive an echo returned in response to the radar wave;
an inertial sensor, configured to detect a terminal motion parameter of the mobile terminal; and
at least one processor, connected with the radar antenna array and the inertial sensor, configured to determine a first relative motion parameter of an object to be detected in an influence scope of the radar wave relative to the mobile terminal based on a transmitting parameter for the radar wave and a receiving parameter for the echo, adjust the first relative motion parameter based on the terminal motion parameter to obtain a second relative motion parameter and perform machine learning on the second relative motion parameter through a preset gesture recognition model to obtain a gesture recognition result.

6. The mobile terminal of claim 5, wherein
the terminal motion parameter comprises at least one of following parameters: an attitude parameter, a movement acceleration, and a rotation angular speed; and
the first relative motion parameter comprises at least one of following relative parameters: a relative speed, a relative angle, and a relative distance.

7. The mobile terminal of claim 6, wherein the at least one processor is configured to:
determine a present mode of the mobile terminal based on the attitude parameter of the mobile terminal, where the present mode of the mobile terminal comprises a landscape mode or a portrait mode;
determine a present coordinate system corresponding to the present mode; and
map the first relative motion parameter into the present coordinate system to obtain the second relative motion parameter.

8. The mobile terminal of claim 6, wherein the at least one processor is configured to:
determine a movement speed and/or movement distance of the mobile terminal according to the movement acceleration, detected by the inertial sensor, of the mobile terminal and
determine a rotation angle of the mobile terminal according to the rotation angular speed, detected by the inertial sensor, of the mobile terminal;
and, the at least one processor is further specifically configured to implement at least one of following:
adjusting the relative speed according to the movement speed of the mobile terminal to determine the second relative motion parameter,
adjusting the relative distance according to the movement distance of the mobile terminal to determine the second relative motion parameter, and
adjusting the relative angle according to the rotation angle of the mobile terminal to determine the second relative motion parameter.

9. A device for gesture detection, comprising:
a processor; and
memory configured to store instructions executable by the processor,
wherein the processor is configured to run the executable instructions stored in the memory to implement operations of:
transmitting a radar wave;
receiving an echo returned in response to the radar wave;
determining a first relative motion parameter of an object to be detected in an influence scope of the radar wave relative to the mobile terminal based on a transmitting parameter for the radar wave and a receiving parameter for the echo;
detecting a terminal motion parameter of the mobile terminal;
adjusting the first relative motion parameter based on the terminal motion parameter to obtain a second relative motion parameter; and
performing machine learning on the second relative motion parameter through a preset gesture recognition model to obtain a gesture recognition result.

10. The device of claim 9, wherein
the terminal motion parameter comprises at least one of following parameters: an attitude parameter, a movement acceleration, and a rotation angular speed; and
the first relative motion parameter comprises at least one of following relative parameters: a relative speed, a relative angle, and a relative distance.

11. The device of claim 10, wherein the processor configured to adjust the first relative motion parameter based on the terminal motion parameter to obtain the second relative motion parameter is further configured to:
determine a present mode of the mobile terminal based on the attitude parameter of the mobile terminal, where the present mode of the mobile terminal comprises a landscape mode or a portrait mode;
determine a present coordinate system corresponding to the present mode; and
map the first relative motion parameter into the present coordinate system to obtain the second relative motion parameter.

12. The device of claim 10, wherein the processor is further configured to:
determine a movement speed and/or movement distance of the mobile terminal according to the movement acceleration of the mobile terminal; and
determine a rotation angle of the mobile terminal according to the rotation angular speed of the mobile terminal;
wherein adjusting the first relative motion parameter based on the terminal motion parameter to obtain the second relative motion parameter comprises at least one of:
adjusting the relative speed according to the movement speed of the mobile terminal to determine the second relative motion parameter;
adjusting the relative distance according to the movement distance of the mobile terminal to determine the second relative motion parameter; and
adjusting the relative angle according to the rotation angle of the mobile terminal to determine the second relative motion parameter.

13. A non-transitory computer-readable storage medium, having stored instructions therein that, when executed by a processor of a device for gesture detection, to cause the device for gesture detection to implement the method of claim 1.

14. The non-transitory computer-readable storage medium of claim 13, wherein
the terminal motion parameter comprises at least one of an attitude parameter, a movement acceleration and a rotation angular speed; and
the first relative motion parameter comprises at least one of following relative parameters: a relative speed, a relative angle, and a relative distance.

15. The non-transitory computer-readable storage medium of claim 14, wherein adjusting the first relative motion parameter based on the terminal motion parameter to obtain the second relative motion parameter comprises:
determining a present mode of the mobile terminal based on the attitude parameter of the mobile terminal, where the present mode of the mobile terminal comprises a landscape mode or a portrait mode;
determining a present coordinate system corresponding to the present mode; and
mapping the first relative motion parameter into the present coordinate system to obtain the second relative motion parameter.

16. The non-transitory computer-readable storage medium of claim 14, wherein the processor is further configured to execute the instructions to implement operations of:
determining a movement speed and/or movement distance of the mobile terminal according to the movement acceleration of the mobile terminal; and
determining a rotation angle of the mobile terminal according to the rotation angular speed of the mobile terminal;
and, adjusting the first relative motion parameter based on the terminal motion parameter to obtain the second relative motion parameter comprises at least one of:
adjusting the relative speed according to the movement speed of the mobile terminal to determine the second relative motion parameter;
adjusting the relative distance according to the movement distance of the mobile terminal to determine the second relative motion parameter; and
adjusting the relative angle according to the rotation angle of the mobile terminal to determine the second relative motion parameter.
